(19) United States
(12) Patent Application Publication
(10) Pub. No.: US 2007/0206550 A1
(43) Pub. Date: Sep. 6, 2007

(54) Method and apparatus for simultaneously processing data in a wireless communication system

(75) Inventors: Maged Zaki, Pierrefonds (CA); Alain Charles Louis Briancon, Poolesville, MD (US); Shamim Akbar Rahman, Montreal (CA); Guy Cote, Boucherville (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/480,066

(22) Filed: Jun. 30, 2006

Related U.S. Application Data
(60) Provisional application No. 60/779,479, filed on Mar. 6, 2006.

(51) Int. Cl. H04Q 7/24

(52) U.S. Cl. 370/338; 370/473; 714/746

(57) ABSTRACT

A method and apparatus for simultaneously processing data in a wireless communication system comprises a wireless transmit/receive unit (WTRU) having a plurality of communication links. The WTRU determines desired characteristics for each communication link. Data traffic is mapped to at least one communication link based on the link characteristics, and a desired redundancy level. The processed data is then transmitted on the at least one communication link, along with the redundancy information.

### CROSS REFERENCE TO RELATED APPLICATION(S)

This application claims the benefit of U.S. Provisional Application No. 60/779,479 filed Mar. 6, 2006, which is incorporated by reference herein as if fully set forth.

### FIELD OF INVENTION

The present invention relates to data transmission in a wireless communication system. In particular, the present invention relates to a method and apparatus for simultaneously processing data in a wireless communication system.

### BACKGROUND

Advancements in mobile technology have shifted a large amount of data storage onto mobile devices, such as laptop computers, Personal Data Assistants (PDAs), wireless transmit/receive units (WTRUs) and the like. The memory capacities of these devices and the ability to network large numbers of them together to share, and store data gives these devices a nearly infinite storage capability.

However, the limited nature of current wireless technologies render them unable to effectively handle the transfer of the ever increasing amounts of data, especially given the current state of the art in data transmission. Currently, wireless devices use only one wireless medium at a time for the transmission of data. That is, they typically transmit their traffic on one physical link, with some wireless devices possessing the ability to switch to another link if the quality of the physical link on which they are transmitting degrades. Congestion on a certain wireless link along with constant searching for better link quality only serve to further degrade the physical link. There are no wireless devices that transmit traffic simultaneously among a plurality of physical channels, and different types of physical channels.

Accordingly, it would therefore be advantageous if a method and apparatus existed that overcomes the drawbacks of prior art wireless systems.

### SUMMARY

A method and apparatus for simultaneously processing data in a wireless communication system comprises a wireless transmit/receive unit (WTRU) having a plurality of communication links. The WTRU determines desired characteristics for each communication link. Data traffic is mapped to at least one communication link based on the link characteristics, and a desired redundancy level. The processed data is then transmitted on the at least one communication link, along with the redundancy information.

### BRIEF DESCRIPTION OF THE DRAWINGS

The foregoing summary, as well as the following detailed description of the preferred embodiments of the present invention will be better understood when read with reference to the appended drawings, wherein:

FIG. 1 is a wireless transmit/receive unit (WTRU) configured in accordance with the present invention;

FIG. 2 is a flow diagram of a method for simultaneously transmitting data, in accordance with the present invention;

FIG. 3 is a flow diagram of a method of receiving simultaneously transmitted data, in accordance with the present invention;

FIG. 4A is a functional block diagram of transmission of data and redundancy information in accordance with an embodiment of the present invention; and

FIG. 4B is a functional block diagram of an alternative transmission of data and redundancy information in accordance with the present invention.

### DETAILED DESCRIPTION OF THE PREFERRED EMBODIMENTS

Hereafter, a wireless transmit/receive unit (WTRU) includes but is not limited to a user equipment, mobile station, fixed or mobile subscriber unit, pager, base station, Node-B, site controller, access point or any other type of device capable of operating in a wireless environment.

The present invention relates to a method and apparatus for simultaneously processing data in a wireless communication system. The method and apparatus provide for the transmission of large quantities of data over multiple links in a fault redundant manner. The features of the present invention may be incorporated into an integrated circuit (IC) or be configured in a circuit comprising a multitude of interconnecting components.

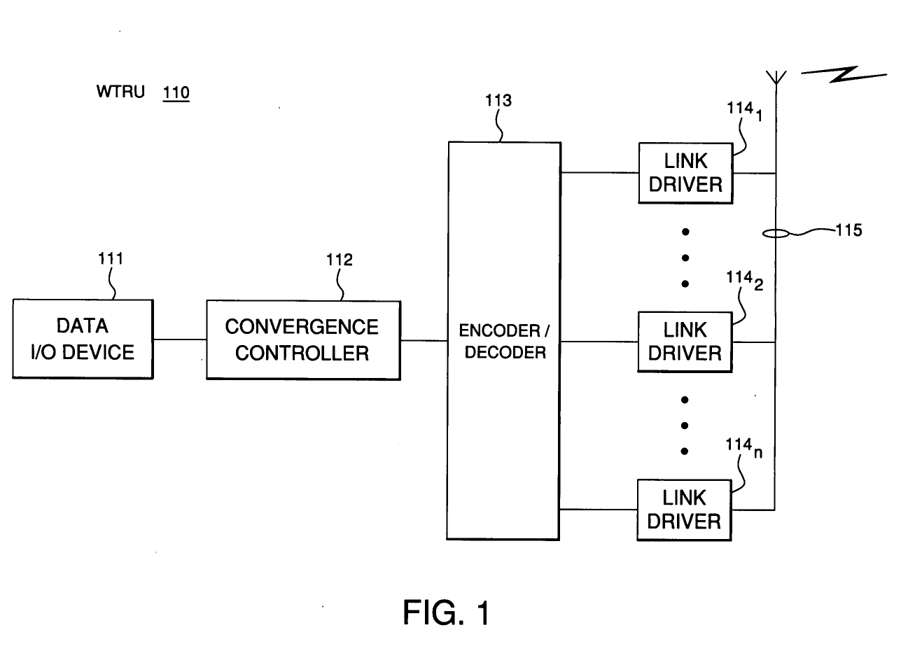

FIG. 1 depicts a WTRU 110 configured in accordance with the present invention. In addition to typical components contained in a typical WTRU, including but not limited to a transmitter and a receiver, the WTRU 110 includes a data input/output (I/O) device 111, a convergence controller 112 in communication with the data I/O device 111, an encoder/decoder 113 in communication with the convergence controller 112, a plurality of link drivers 114 (designated 114₁, 114₂ . . . 114ₙ) in communication with the encoder/decoder 113, and an antenna 115 in communication with the plurality of link drivers 114.

The data I/O device 111 provides data to be transmitted by the WTRU 110. The data I/O device 111 may be a keyboard, mouse, keypad, memory card, or any other device for providing data to the WTRU 110. In addition, the data I/O device may be utilized for storing data received by the WTRU 110.

The convergence controller 112 receives data from the data I/O device 111 and selectively transmits the data via the link drivers 114. The function of the convergence controller 112 will be described in greater detail hereafter. In general, however, the convergence controller 112 determines and stores information about link types, characteristics, quality and speed, calculates a redundancy metric index for each link and the collection of links, and distributes the data on the link drivers 114.

The encoder/decoder 113 encodes the data received from the convergence controller 112 and forwards it to the appropriate link drivers 114 for transmission. For example, the encoder/decoder 113 may employ cyclic redundancy check (CRC) encoding.

The plurality of link drivers 114 receive the data from the encoder/decoder 113 and transmit the data via the antenna 115. Each link driver 114₁, 114₂ . . . 114ₙ is associated with an individual communication link which may be associated with the same, or a different, transmission protocol. For example, link driver 114₁ may be an ethernet protocol driver. Link driver 114₂ may be a wireless local area network (WLAN) driver such as 802.11a, 802.11g driver or the like. Link driver 114ₙ may be a cellular driver. Each link driver 114 may also be configured to transmit via a personal computer memory card international association (PCMCIA) card that may be installed in a PCMCIA slot on a personal computer.

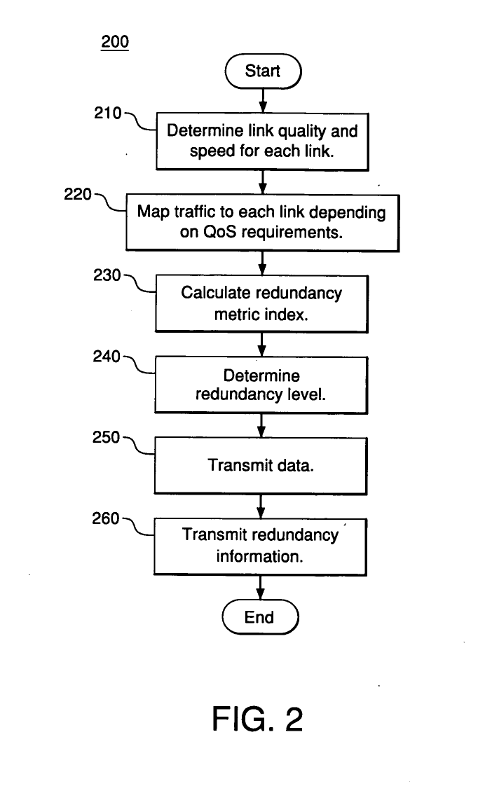

FIG. 2 is a flow diagram of a method for simultaneously transmitting data 200, in accordance with the present invention. In step 210, the convergence controller 112 determines one or more characteristics for each communication link, such as the link quality and speed for each link. In order to do this, the convergence controller 112 collects information from the link drivers 114 relating to their type, characteristics, transmission quality and speed.

Next, the convergence controller 112 calculates the amount of data that can be sent on each link and maps the data traffic stream to each link in accordance with the quality of service (QoS) requirements for the traffic (step 220). That is, each link utilized should satisfy the bandwidth and delay requirements of a specific data traffic stream. In one embodiment, one data traffic stream may be mapped to multiple links so that a larger amount of data may be transmitted in a shorter amount of time. Additionally, multiple data traffic streams may be mapped to one or more links, where data traffic streams mapped to one link or a group of links should have similar QoS requirements. This may facilitate scheduling and admission control. The convergence controller 112 may also map data traffic streams to one link if mapping it to multiple links will cause an unwanted increase in transmission delay for real time services.

After the convergence controller 112 has mapped the data traffic streams (step 220), it calculates the redundancy metric index (step 230). The redundancy metric index determines the amount of redundant information that should be transmitted. It is a function of the link type, the link quality, the link capacity, and the required QoS for the transmitted data traffic stream. From this calculation, the convergence controller 112 determines the redundancy level (step 240), where the redundancy level “n” is a value greater than zero that will ensure that if “n” links fail for any reason, a receiver will be able to recover the transmitted data.

The convergence controller 112 transmits the data via the link drivers 114 through the encoder/decoder 113 (step 250). Redundancy information is transmitted (step 260) in accordance with the determination made by the convergence controller 112.

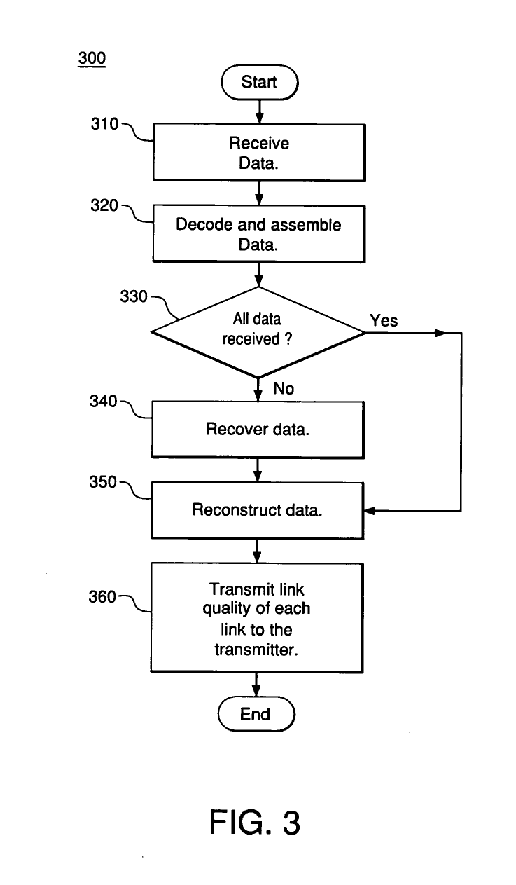

FIG. 3 is a flow diagram depicting a method of receiving simultaneously transmitted data 300, in accordance with the present invention. In step 310, the WTRU 110 receives a data traffic stream via the link drivers 114. The received data traffic stream is forwarded to the encoder/decoder 113 where it is decoded and forwarded to the convergence controller 112 where it is assembled (step 320).

The convergence controller 112 determines whether all the data has been received intact (step 330). If all the data has been received intact, then the convergence controller reconstructs the data (step 350). If some, or all, of the data has not been received intact, then the convergence controller performs a data recovery procedure on the data (step 340) prior to reconstructing the data (step 350). The convergence controller 112 of the receiving WTRU 110 then transmits the link quality of each link to the transmitting WTRU (step 360). In a preferred embodiment of the present invention, error correction coding algorithms are used to recover the data. For example, in one embodiment, an “exclusive-or” (xor) function may be performed between two or more packets to create a packet containing the xor operation. The xor operation packet may then be transmitted on a reliable link to the device that is the remote. If one of the original packets was detected to be erroneous, such as by the CRC in the packet, the xor operation packet may be utilized to reconstruct the erroneous packet.

The convergence controller 112 may determine to transmit the redundancy information 400 over a single link, such as the most reliable link, or the redundancy information 400 may be spread over a plurality of links.

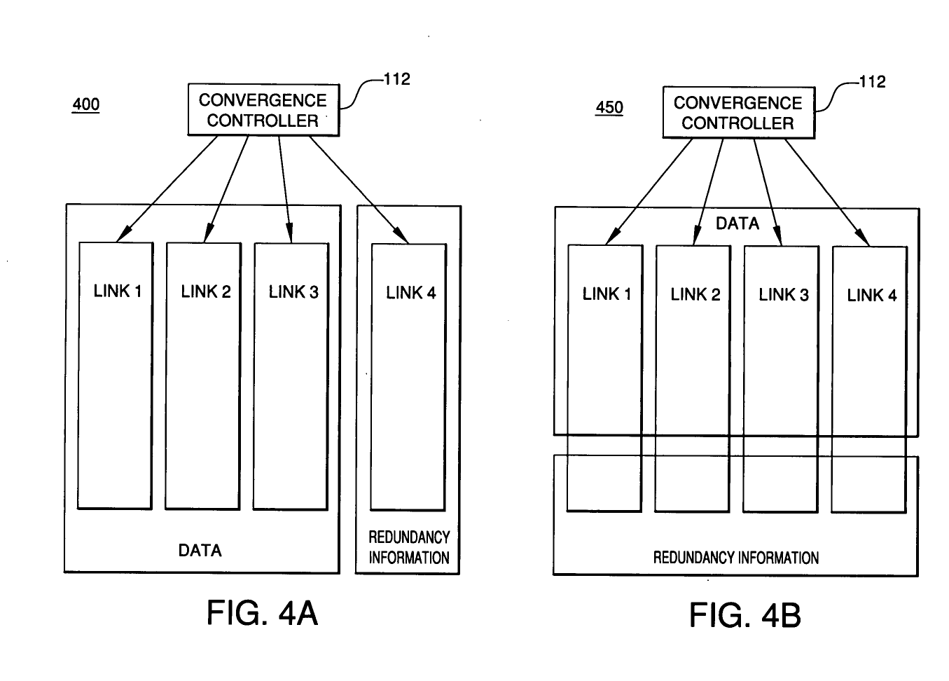

FIG. 4A is a functional block diagram depicting a transmission of data and redundancy information 400. The diagram shows the convergence controller 112 transmitting data and redundancy information over four (4) links, designated Link1, Link2, Link3, and Link4. In the present example, the convergence controller 112 has determined that a particular link (Link4) is the most reliable link, and therefore distributes the data traffic stream on Link1, Link2, and Link3, but transmits all redundancy information on Link4.

FIG. 4B is a functional block diagram depicting an alternative transmission of data and redundancy information 450. Similarly to FIG. 4A, the diagram shows the convergence controller 112 transmitting data and redundancy information over four (4) links, designated Link1, Link2, Link3, and Link4. In this present example, however, the convergence controller 112 has determined that all four links possess the same quality level and are equally reliable. Accordingly, the convergence controller 112 distributes both the data and the redundancy information equally among Link1, Link2, Link3, and Link4.

The present invention may be implemented in any type of wireless communication system, as desired. By way of example, the present invention may be implemented in any type of 802 type system, WCDMA, TDD, HCR, LCR, TDS-CDMA, FDD, CDMA2000, IXEV-DO, IXEV-DV, GSM, EDG, GPRS, CDMA (IS-95), TDMA (IS-136) or any other type of wireless communication system. The present invention may also be implemented on an integrated circuit, such as an application specific integrated circuit (ASIC), multiple integrated circuits, logical programmable gate array (LPGA), multiple LPGAs, DSP, software, middleware, discrete components, or a combination of integrated circuit(s), LPGA(s), and discrete component(s).

Although the features and elements of the present invention are described in the preferred embodiments in particular combinations, each feature or element can be used alone (without the other features and elements of the preferred embodiments) or in various combinations with or without other features and elements of the present invention.

What is claimed is:

1. A method for simultaneously processing data in a wireless communication system comprising at least one wireless transmit/receive unit (WTRU), the WTRU including a plurality of communication links, the method comprising:
determining a link characteristic for each communication link;
mapping data traffic to at least one communication link based on the link characteristic;
determining a redundancy level;
transmitting the data traffic on the at least one communication link; and
transmitting redundancy information.

2. The method of claim 1 wherein each communication link of the plurality of communication links is associated with a particular communication protocol.

3. The method of claim 1, further comprising the step of collecting information from each communication link to determine the link characteristic for each communication link.

4. The method of claim 3 wherein the collected information includes information related to the type of link, transmission quality of the link, and the transmission speed of the link.

5. The method of claim 1 wherein data traffic is mapped to one communication link.

6. The method of claim 1 wherein data traffic is mapped to a plurality of communication links.

7. The method of claim 6 wherein transmitting redundancy information includes transmitting redundancy information over one communication link.

8. The method of claim 7 wherein the redundancy information is transmitted over the communication link having a highest reliability level.

9. The method of claim 6 wherein transmitting redundancy information includes transmitting redundancy information over a plurality of communication links.

10. The method of claim 9 wherein the redundancy information is transmitted over a plurality of communication links having equal reliability levels.

11. The method of claim 1 wherein determining a redundancy level includes calculating a redundancy metric index.

12. The method of claim 11 wherein the redundancy metric index is calculated from any one of the communication link type, the communication link quality, the communication link capacity, and the required quality of service (QoS) of a data traffic stream.

13. The method of claim 11 wherein the redundancy metric index is calculated from a combination of the communication link type, the communication link quality, the communication link capacity, and the required quality of service (QoS) of a data traffic stream.

14. The method of claim 1, further comprising encoding the data traffic stream prior to transmitting the data traffic stream.

15. The method of claim 14 wherein the encoding is cyclic redundancy check (CRC) encoding.

16. The method of claim 1, further comprising receiving the transmitted data traffic streams.

17. The method of claim 16, further comprising decoding the received data traffic streams.

18. The method of claim 16, further comprising assembling the received data traffic streams.

19. The method of claim 18, further comprising recovering data where all transmitted data is not received.

20. The method of claim 19, further comprising reconstructing data from the data traffic stream.

21. The method of claim 18, further comprising reconstructing data from the data traffic stream.

22. The method of claim 18, further comprising transmitting the link quality of each communication link.

23. In a wireless communication system comprising a plurality of wireless transmit/receive units (WTRUs), each WTRU comprising:
a data input/output (I/O) device;
a convergence controller; and
a plurality of communication link drivers associated with a plurality of communication links;
wherein the convergence controller is configured to receive data from the data I/O device, determine a link characteristic for each communication link driver, map data traffic to at least one communication link driver based on the link characteristic, determine a redundancy level, transmit the data traffic along the at least one communication link driver, and transmit redundancy information.

24. The WTRU of claim 23, further comprising an encoder/decoder in communication with the convergence controller and the plurality of link drivers, said encoder/decoder configured to encode a data traffic stream for transmission over the plurality of link drivers.

25. The WTRU of claim 23 wherein each communication link driver is associated with a particular communication protocol.

26. The WTRU of claim 23 wherein the convergence controller is further configured to recover data received from another WTRU and reconstruct the data.

27. The WTRU of claim 23 wherein the convergence controller is further configured to transmit the link quality of each communication link driver to another WTRU.

28. In a wireless communication system comprising a plurality of wireless transmit/receive units (WTRUs), each WTRU including an integrated circuit (IC) comprising:
a data input/output (I/O) device;
a convergence controller; and
a plurality of communication link drivers associated with a plurality of communication links;
wherein the convergence controller is configured to receive data from the data I/O device, determine a link characteristic for each communication link driver, map data traffic to at least one communication link driver based on the link characteristic, determine a redundancy level, transmit the data traffic along the at least one communication link driver, and transmit redundancy information.

29. The IC of claim 28, further comprising an encoder/decoder in communication with the convergence controller and the plurality of link drivers, said encoder/decoder configured to encode a data traffic stream for transmission over the plurality of link drivers.

30. The IC of claim 28 wherein each communication link driver is associated with a particular communication protocol.

31. The IC of claim 28 wherein the convergence controller is further configured to recover data received from another WTRU and reconstruct the data.

32. The IC of claim 28 wherein the convergence controller is further configured to transmit the link quality of each communication link driver to another WTRU.
